(19) United States
(12) Patent Application Publication
(10) Pub. No.: US 2023/0418009 A1
(43) Pub. Date: Dec. 28, 2023

(54) THERMAL MANAGEMENT OF COMPUTER HARDWARE MODULES

(71) Applicant: INTERNATIONAL BUSINESS MACHINES CORPORATION, Armonk, NY (US)

(72) Inventors: Yuanchen Hu, Peekskill, NY (US); Sushumna Iruvanti, Wappingers Falls, NY (US); Philipp K Buchling Rego, Wappingers Falls, NY (US)

(21) Appl. No.: 17/849,679

(22) Filed: Jun. 26, 2022

(51) Int. Cl. G02B 6/42

(52) U.S. Cl. CPC G02B 6/4269; G02B 6/4292; H04B 10/40

(57) ABSTRACT

Aspects of the disclosure include a structure for thermal management of pluggable hardware modules, an optical transceiver, and a method of cooling a pluggable hardware module. One embodiment of the structure may comprise a socket assembly adapted to receive a hardware module. The socket assembly may comprise an integrated fluid reservoir containing a thermal interface material (TIM). The socket assembly may be further adapted to define a gap when the hardware module is plugged into the socket assembly. The structure may further comprise at least one dispensing port in fluid communication with the integrated fluid reservoir and the gap. The at least one dispensing port may be adapted to automatically distribute TIM from the integrated fluid reservoir into the gap when the hardware module is plugged into the socket assembly.

### BACKGROUND

The present disclosure relates to thermal management, and more specifically, to thermal management of pluggable hardware modules via a self-contained thermal interface material.

The development of the EDVAC system in 1948 is often cited as the beginning of the computer era. Since that time, computer systems have evolved into extremely complicated devices. Today's computer systems typically include a combination of sophisticated hardware and software components, application programs, operating systems, processors, buses, memory, input/output devices, and so on. As advances in semiconductor processing and computer architecture push performance higher and higher, even more advanced computer software has evolved to take advantage of the relatively higher performance of those capabilities, resulting in computer systems today that are more powerful than just a few years ago.

Optical transceivers are used extensively in computer systems, particular those used in datacenters, high performance computing (HPC), and other systems that utilize high performance computing networking. One common optical transceiver form factor includes printed circuit board (PCB) mounted laser/optical modules packaged within a molded metallic housing. This module assembly may plug into a socket in the host computing system, which may be provisioned as a server in a datacenter, integrated into a HPC system, or the like.

### SUMMARY

According to embodiments of the present disclosure, a structure for thermal management of pluggable hardware modules comprising a socket assembly adapted to receive a hardware module. The socket assembly may comprise an integrated fluid reservoir containing a thermal interface material (TIM). The socket assembly may be further adapted to define a gap when the hardware module is plugged into the socket assembly. The structure may further comprise at least one dispensing port in fluid communication with the integrated fluid reservoir and the gap. The at least one dispensing port may be adapted to automatically distribute TIM from the integrated fluid reservoir into the gap when the hardware module is plugged into the socket assembly.

According to embodiments of the present disclosure, an optical transceiver, comprising at least one optical module packaged within a housing. The housing may comprise a generally rectangular top surface defining a pattern adapted to enhance capillary action of a thermal interface material (TIM) applied thereon. The top surface may comprise a groove. The groove may be adapted to receive a seal when the housing is inserted into a socket.

According to embodiments of the present disclosure, a method of cooling a pluggable hardware module, comprising providing a socket assembly. The socket assembly may comprise an integrated fluid reservoir containing a thermal interface material (TIM). The method may further comprise providing a hardware module. The hardware module and the socket assembly may be adapted to define a gap when the hardware module is plugged into the socket assembly. The method may further comprise providing at least one dispensing port in fluid communication with the integrated fluid reservoir and the gap. The method may further comprise plugging the hardware module into the socket, wherein the at least one dispensing port is adapted to automatically distribute TIM from the integrated fluid reservoir into the gap when the hardware module is plugged into the socket assembly.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates one embodiment of a data processing system (DPS), consistent with some embodiments.

FIG. 2A is a cross-section rear view and FIG. 2B is a cross-section side view of a first hardware assembly suitable for use as a system interface, consistent with some embodiments.

FIG. 3A is a cross-section rear view and FIG. 3B is a cross-section side view of a second hardware assembly suitable for use as a system interface, consistent with some embodiments.

FIG. 4A is a cross-section rear view and FIG. 4B is a cross-section side view of a third hardware assembly suitable for use as a system interface, consistent with some embodiments.

FIGS. 5A-5D are cross sectional views of a first embodiment of the upper openings of a primary fluid reservoir, consistent with some embodiments.

FIGS. 6A-6D are cross sectional views of a second embodiment of the upper openings of a primary fluid reservoir, consistent with some embodiments.

FIGS. 7A-7D are cross sectional views of a third embodiment of the upper openings of a primary fluid reservoir, consistent with some embodiments.

FIG. 8 is a table showing a simulated thermal analysis of traditional dry contact vs. the embodiments disclosed herein.

FIGS. 9A-9B are a cross-section rear view of the second hardware assembly in operation.

FIG. 10 is a flow chart illustrating one method of cooling a hardware module in a DPS, consistent with some embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to thermal management; more particular aspects relate to thermal management of pluggable hardware modules via a self-contained thermal interface material. While the present disclosure is not necessarily limited to such applications, various aspects of the disclosure may be appreciated through a discussion of various examples using this context.

System designers have been specifying more-dense designs and ever-faster speeds for computer hardware, including pluggable hardware modules. These increased speeds, however, are typically accompanied with greater heat generation, which may be difficult to dissipate given the increased densities.

While conventional socket assemblies have included a passive heat sink, the performance of that heat sink has been limited by the dry contact interface between the module and the socket. That is, the high thermal impedance of air has greatly limited the practical ability to cool pluggable hardware modules. Additionally, thermal pad use (even pre-applied) is not practical in many pluggable hardware modules and socket assemblies, as the pad will get scraped, torn or damaged and pile up in the interface, making the module-socket engagement difficult. Accordingly, one aspect of this disclosure is a method and system for automatically applying a thermal interface material (TIM) for dissipating the heat generated by pluggable hardware modules (“modules”), such as optical transceivers, interconnects, etc. These methods and systems may be particularly desirable in modern, highly dense, thermally-demanding computing systems used in datacenters and HPC.

In some embodiments, pluggable hardware modules that require additional cooling may be adapted for insertion into a socket assembly. The socket assembly may comprise a socket that is physically and thermally connected to a heat sink. The heat sink, in turn, may define a cavity in its bottom surface. The heat sink may cooperate with the socket to define a TIM supply reservoir when clamped together by one or more spring retaining clips. The TIM supply reservoir may be filled with liquid or semisolid TIM at a manufacturing site or at a location where it is to be used.

The TIM in the TIM supply reservoir may comprise a liquid material (e.g., PolyAlphaOlefin (PAO) oil, etc.); a semi-solid material (e.g., a low viscosity/flowable thermal grease containing suspended sub-micron or nano silver or ceramic fillers, etc.); a liquid metal (e.g., Gallium, GaInSn (Galinstan), or GaIN); or another thermally-conductive heat-transfer medium. Embodiment using PAO oil may be particularly desirable for some applications because this TIM can have relatively high viscosity, has been certified by many manufacturers for use as a TIM, has a relatively high thermal conductivity of around 0.18-0.2 W/mK, may allow for a relatively thin TIM layer (e.g., between about 0.025-0.05 mm), and can be cleaned by a cloth or isopropyl alcohol (IPA) if needed. Embodiments using liquid metal may be desirable for some applications because these TIMs typically have relatively high thermal conductivity (e.g., 40 W/mK) and surface tension properties.

The TIM supply reservoir may feature at least one (and in some embodiments, multiple) dispensing ports. The dispensing port(s) may be sized such that, prior to plugging of the hardware module, the surface tension of the TIM balances gravity forces. In this way, the TIM (including liquid TIM embodiments) may remain in the dispensing port and/or TIM supply reservoir prior to insertion of the hardware module into the socket assembly.

In operation, after plugging of the module into the socket assembly, a gap may be formed between a top/lid surface of the hardware module and an interior surface of the socket/socket assembly. The gap may be bounded on its periphery by a gasket/seal to retain TIM in the gap (e.g., to form a temporary reservoir for the TIM). In some embodiments, the TIM may automatically flow from the TIM supply reservoir into the gap to form, in-situ, a TIM layer. In some embodiments, the walls of the gap (e.g., top/lid surface of the hardware module and/or the interior surface of the socket/socket assembly) may be roughened and/or patterned to facilitate/enhance capillary flow of the TIM into and through the gap. In this way, the roughened surface may facilitate wetting, i.e., filling the gap with TIM after plugging/re-plugging of the hardware module. Additionally or alternatively, a positive pressure may be applied (e.g., by the heat sink retaining spring and/or via plunger actuated as part of the insertion operation) to further enhance TIM flow into the gap.

In some embodiments, the TIM supply reservoir may be sized such that its volume greatly exceeds dispensed volume. For example, a reservoir-volume-to-dispensed-volume ratio may be greater than about 10×, 25×, or 50× for certain optical transceiver embodiments. In this way, these embodiments may enable multiple (e.g., 10×, 25× or 50×) plug/removal/re-plug cycles of the optical transceiver. Additionally, in some embodiments, the TIM supply reservoir may be refillable if additional cycles are desired. Moreover, some embodiments may include one or more check valves to control the TIM dispensation during multiple plugging/re-plugging cycles and/or to prevent TIM leakage.

Accordingly, one aspect of the disclosure is socket assembly for, e.g., optoelectronic hardware modules, in which TIM may be stored in an integrated reservoir. The TIM from the integrated reservoir may be automatically applied, in-situ, when the hardware module is plugged-in, forming a TIM layer that may enhance the thermal interface between the hardware module and the heat sink. Some embodiments may further enable a repeated plug/re-plug cycle without significant damage or degradation in the performance of this enhanced thermal interface by including a reservoir and dispense and fill ports of sufficient volume to store and/or dispense TIM during each plug/re-plug event. Another aspect of the disclosure is a structure that enables in-situ dispensing of TIM with supplemental positive pressure applied with heat sink retaining clips/springs.

Other features and advantages of some embodiments may include an optimally designed heat sink wall thickness, reservoir volume, dispense and fill port diameters, and check-valves to provide for positive pressure to dispense TIM for plug/re-plug. Some embodiments may also include surface roughness to enhance wetting, and perimeter grooves/gaskets along at least one edge to prevent TIM overflow.

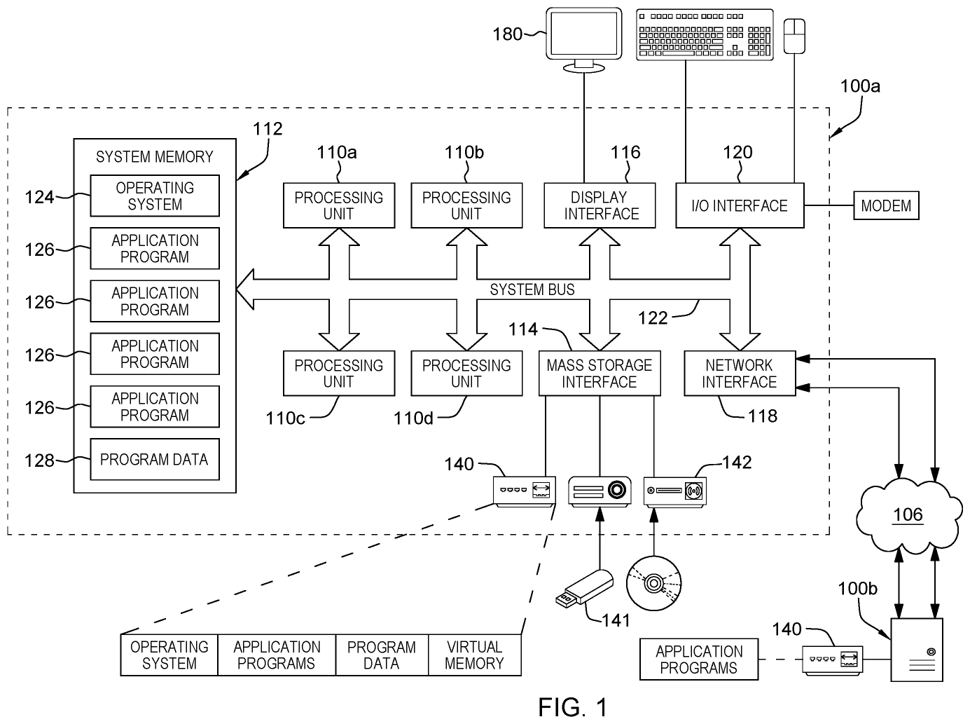

FIG. 1 illustrates one embodiment of a data processing system (DPS) 100a, 100b (herein generically referred to as a DPS 100), consistent with some embodiments. FIG. 1 only depicts the representative major components of the DPS 100, and those individual components may have greater complexity than represented in FIG. 1. In some embodiments, the DPS 100 may be implemented as a personal computer; server computer; portable computer, such as a laptop or notebook computer, personal data assistant (PDA), tablet computer, or smartphone; processors embedded into larger devices, such as an automobile, airplane, teleconferencing system, appliance; smart devices; or any other appropriate type of electronic device. Moreover, components other than or in addition to those shown in FIG. 1 may be present, and the number, type, and configuration of such components may vary.

The DPS 100 in FIG. 1 may comprise a plurality of processing units 110a-110d (generically, processor 110 or CPU 110) that may be connected to a main memory 112, a mass storage interface 114, a terminal/display interface 116, a network interface 118, and an input/output (“I/O”) interface 120 by a system bus 122. The mass storage interface 114 in this embodiment may connect the system bus 122 to one or more mass storage devices, such as a direct access (or mass) storage device 140, a USB drive 141, and/or a readable/writable optical disk drive 142. The network interface 118 may allow the DPS 100a to communicate with other DPS 100b over a network 106. The main memory 112 may contain an operating system 124, a plurality of application programs 126, and program data 128.

The DPS 100 embodiment in FIG. 1 may be a general-purpose computing device. In these embodiments, the processors 110 may be any device capable of executing program instructions stored in the main memory 112, and may themselves be constructed from one or more microprocessors and/or integrated circuits. In some embodiments, the DPS 100 may contain multiple processors and/or processing cores, as is typical of larger, more capable computer systems; however, in other embodiments, the DPS 100 may only comprise a single processor system and/or a single processor designed to emulate a multiprocessor system. Further, the processor(s) 110 may be implemented using a number of heterogeneous data processing systems in which a main processor 110 is present with secondary processors on a single chip. As another illustrative example, the processor(s) 110 may be a symmetric multiprocessor system containing multiple processors 110 of the same type.

When the DPS 100 starts up, the associated processor(s) 110 may initially execute program instructions that make up the operating system 124. The operating system 124, in turn, may manage the physical and logical resources of the DPS 100. These resources may include the main memory 112, the mass storage interface 114, the terminal/display interface 116, the network interface 118, and the system bus 122. As with the processor(s) 110, some DPS 100 embodiments may utilize multiple system interfaces 114, 116, 118, 120, and buses 122, which in turn, may each include their own separate, fully programmed microprocessors.

Instructions for the operating system 124 and/or application programs 126 (generically, “program code,” “computer usable program code,” or “computer readable program code”) may be initially located in the mass storage devices 140, which are in communication with the processor(s) 110 through the system bus 122. The program code in the different embodiments may be embodied on different physical or tangible computer-readable media, such as the memory 112 or the mass storage devices 140. In the illustrative example in FIG. 1, the instructions may be stored in a functional form of persistent storage on the direct access storage device 140. These instructions may then be loaded into the main memory 112 for execution by the processor(s) 110. However, the program code may also be located in a functional form on the computer-readable media, such as the direct access storage device 140 or the readable/writable optical disk drive 142, that is selectively removable in some embodiments. It may be loaded onto or transferred to the DPS 100 for execution by the processor(s) 110.

With continuing reference to FIG. 1, the system bus 122 may be any device that facilitates communication between and among the processor(s) 110; the main memory 112; and the interface(s) 114, 116, 118, 120. Moreover, although the system bus 122 in this embodiment is a relatively simple, single bus structure that provides a direct communication path among the system bus 122, other bus structures are consistent with the present disclosure, including without limitation, point-to-point links in hierarchical, star or web configurations, multiple hierarchical buses, parallel and redundant paths, etc.

The main memory 112 and the mass storage device(s) 140 may work cooperatively to store the operating system 124, the application programs 126, and the program data 128. In some embodiments, the main memory 112 may be a random-access semiconductor memory device (“RAM”) capable of storing data and program instructions. Although FIG. 1 conceptually depicts the main memory 112 as a single monolithic entity, the main memory 112 in some embodiments may be a more complex arrangement, such as a hierarchy of caches and other memory devices. For example, the main memory 112 may exist in multiple levels of caches, and these caches may be further divided by function, such that one cache holds instructions while another cache holds non-instruction data that is used by the processor(s) 110. The main memory 112 may be further distributed and associated with a different processor(s) 110 or sets of the processor(s) 110, as is known in any of various so-called non-uniform memory access (NUMA) computer architectures. Moreover, some embodiments may utilize virtual addressing mechanisms that allow the DPS 100 to behave as if it has access to a large, single storage entity instead of access to multiple, smaller storage entities (such as the main memory 112 and the mass storage device 140).

Although the operating system 124, the application programs 126, and the program data 128 are illustrated in FIG. 1 as being contained within the main memory 112 of DPS 100a, some or all of them may be physically located on a different computer system (e.g., DPS 100b) and may be accessed remotely, e.g., via the network 106, in some embodiments. Moreover, the operating system 124, the application programs 126, and the program data 128 are not necessarily all completely contained in the same physical DPS 100a at the same time, and may even reside in the physical or virtual memory of other DPS 100b.

The system interfaces 114, 116, 118, 120 in some embodiments may support communication with a variety of storage and I/O devices. The mass storage interface 114 may support the attachment of one or more mass storage devices 140, which may include rotating magnetic disk drive storage devices, solid-state storage devices (SSD) that uses integrated circuit assemblies as memory to store data persistently, typically using flash memory or a combination of the two. Additionally, the mass storage devices 140 may also comprise other devices and assemblies, including arrays of disk drives configured to appear as a single large storage device to a host (commonly called RAID arrays) and/or archival storage media, such as hard disk drives, tape (e.g., mini-DV), writable compact disks (e.g., CD-R and CD-RW), digital versatile disks (e.g., DVD, DVD-R, DVD+R, DVD+RW, DVD-RAM), holography storage systems, blue laser disks, IBM® Millipede devices, and the like. The I/O interface 120 may support attachment of one or more I/O devices, such as a keyboard, mouse, modem, or printer (not shown)

The terminal/display interface 116 may be used to directly connect one or more displays 180 to the DPS 100. These displays 180 may be non-intelligent (i.e., dumb) terminals, such as a light-emitting diode (LED) monitor, or may themselves be fully programmable workstations that allow information technology (IT) administrators and users to communicate with the DPS 100. Note, however, that while the display interface 116 may be provided to support communication with one or more displays 180, the DPS 100 does not necessarily require a display 180 because all needed interaction with users and other processes may occur via the network 106.

The network 106 may be any suitable network or combination of networks and may support any appropriate protocol suitable for communication of data and/or code to/from multiple DPS 100. Accordingly, the network interfaces 118 may be any device that facilitates such communication, regardless of whether the network connection is made using present-day analog and/or digital techniques or via some networking mechanism of the future. Suitable networks 106 include, but are not limited to, networks implemented using one or more of the “InfiniBand” (TB) or Institute of Electrical and Electronics Engineers (IEEE) 802.3x “Ethernet” specifications; cellular transmission networks; wireless networks implemented one of the IEEE 802.11x, IEEE 802.16, General Packet Radio Service (“GPRS”), Family Radio Service (FRS), or Bluetooth specifications; Ultra-Wide Band (“UWB”) technology, such as that described in FCC 02-48; or the like. Those skilled in the art will appreciate that many different network and transport protocols may be used to implement the network 106. The Transmission Control Protocol/Internet Protocol (“TCP/IP”) suite contains a suitable network and transport protocols.

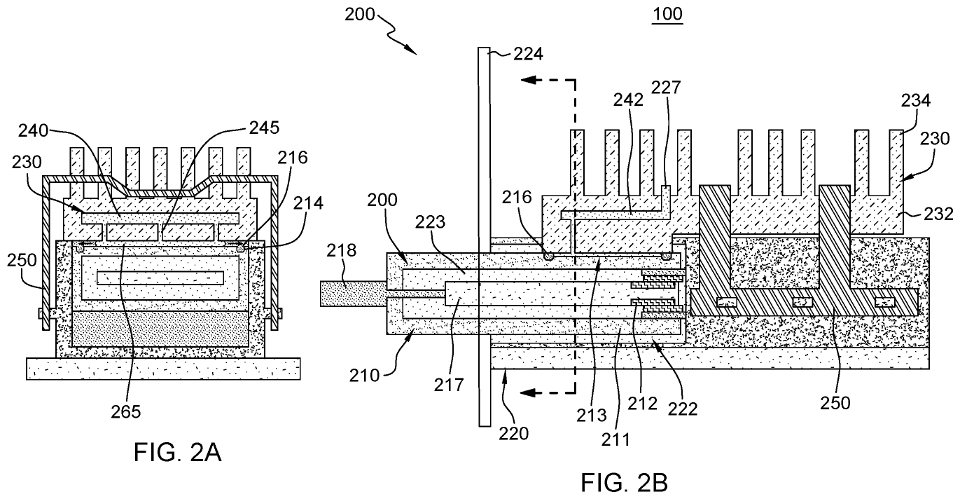

FIG. 2A is a cross-section rear view and FIG. 2B is a cross-section side view of a first hardware assembly 200 suitable for use as one of the system interfaces 114-120, consistent with some embodiments. The hardware assembly 200 may comprise a hardware module 210 (e.g., an optical transceiver) and a socket assembly 220.

The hardware module 210 may comprise a plurality of optical modules (e.g., transceivers) 213 positioned and adapted to automatically mate with corresponding receptors 222 in the socket assembly 220 when the hardware module 210 is plugged, e.g., via an opening 223 in an exterior wall 224 of the DPS 100 (or other housing or rack containing the hardware module 210). In some embodiment, the hardware module 210 may include a molded housing 211 having a generally rectangular top surface 212. A gasket/seal 216 may extend around completely or partially along the peripheral edges of the top surface 212, and may be retained by a corresponding retaining groove 214. Alternatively, groove 214 may be adapted to receive a gasket/seal (not shown) attached to the socket assembly 220. The hardware module 210 may further comprise a printed circuit board 217 onto which the optical modules 213 are mounted, and a communication cable 218.

The socket assembly 220 may comprise a socket 222 and a heat sink 230. The heat sink 230 comprise a base 232 physically and thermally connected to a plurality of cooling vanes 234. The base 232 of the heat sink 230 may define a cavity such that, when the heat sink 230 is clamped onto and biased against the socket 221 by a retaining clip 250, the heat sink 230 and socket 222 cooperate to define a TIM supply reservoir 240. The TIM supply reservoir 240 may be filled with a liquid or quasi-liquid thermal interface material (TIM) 242 via an upper opening 227.

The base 232 of the heat sink 230 may also define at least one dispensing port 245. In some embodiments, the dispensing port 245 may be sized such that a surface tension of the TIM 242 is balanced with gravity and/or fluid pressure. In these embodiments, the TIM 242 will tend to remain in the TIM supply reservoir 240 prior to plugging of the hardware module 210 into the socket assembly 220. The upper opening 227, in contrast, may have a relatively larger diameter than the dispensing port 245 in some embodiments for ease of filling of the TIM supply reservoir 240.

In operation, the fluid reservoir 240 may be sealed using temporary plugs or tape (not shown) to prevent leakage during shipping. To begin installation, a computer administrator may first remove these plugs/tape, and then insert the hardware module 210 through the opening 223 in the exterior wall 224 of the DPS 100, and then into the socket assembly 220. When the hardware module 210 is fully inserted, the top surface of the hardware module 210, the inner surface of the socket 222, and the gasket/seal 216 may cooperate to define a gap 265 (e.g., between the electronic hardware module to-be-cooled and the heat sink). In some embodiments, this gap 265 may be relatively thin/shallow, such that plugging/re-plugging of the hardware module 210 will break the surface tension holding the TIM 242 in the TIM supply reservoir 240, allowing the TIM 242 to flow into the gap 265 via gravity and/or capillary action. The gasket/seal 216 may retain the TIM 242 in the gap 265 while the hardware module 210 is plugged into the socket assembly 220.

In these embodiments, the inner surface of the socket 222 and a top surface of the hardware module 210 may be roughened and/or patterned to enhance the capillary flow, which may help the TIM 242 to completely fill the gap 265. Additionally or alternatively, heat generated by the hardware module 210 during its operation may heat the TIM 242, which may reduce its viscosity. This change in viscosity may further enable the TIM 242 to naturally flow into the gap 265. Advantageously, the TIM 242 may then act as a “wet” contact interface, which may increase heat transfer from the hardware module 210 through the base 232 and into the cooling vanes 234 as compared to a “dry” contact interface.

The diameter of the dispensing port 245 may be optimized for capillary retention and dispensing. Liquid TIM may flow out of the dispenser port 245 when force from pressure on the TIM from e.g., the retaining clip (Fₚ)+force from gravity (F_{g})>capillary force (F_{c}). Put differently, TIM may flow out of the dispensing port 245 when Fₚ overcomes F_{c} minus F_{g} where:

F_{g}=m*g=ρ*volume*g
and assuming the dispensing port is a cylinder:

F_{g}=ρ*π*r²*height
In one illustrative embodiment, this may equal:

800 kg/m³*3.14*0.001 m*0.001 m*0.0015 m*9.8 m/s²=3 0.6*10⁻⁵ N
F_{c}, in turn, may equal:

F_{c}=2*π*r*σ*cos(θ)
where σ is a surface tension of the chosen TIM material and angle θ is an angle of contact of the TIM with the dispensing port 245. Continuing the above illustrative example, with σ=30 N/m and angle θ=60 degrees, this results in F_{c}=9.4*10⁻² N. The retaining clip (or other biasing structure) may be designed to provide force larger than (9.4*10⁻² N−3.6*10⁻⁵ N)≈9.4*10⁻² N.

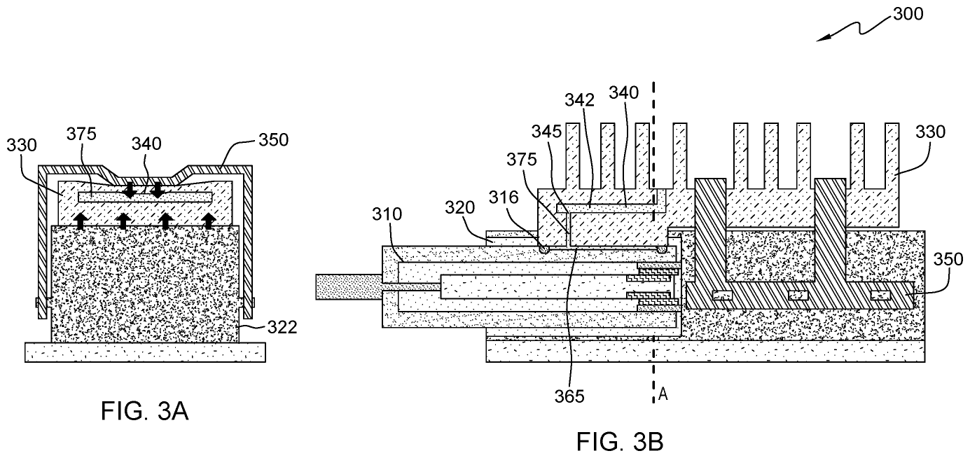

FIG. 3A is a cross-section rear view and FIG. 3B is a cross-section side view of a second hardware assembly 300 suitable for use as one of the system interfaces 114-120, consistent with some embodiments. Hardware assembly 300 is similar to hardware assembly 200 in FIGS. 2A-2B. However, in hardware assembly 300, the dispensing port 345 may include a valve 375 that is automatically actuated from a normally-closed position into an open position when the hardware module 310 is plugged into the socket 320. The opening of valve 375 may allow the TIM 342 to flow into the gap 365. In this embodiments, a top surface 370 of a primary fluid reservoir 340 may be relatively thin and flexible. A retaining clip 350 may impart a biasing force onto the flexible top surface 370 of the heat sink 330, causing it to deflect downward into the primary fluid reservoir 340. That deflection, in turn, may pressurize the TIM 342, forcing the TIM 342 into secondary fluid reservoir 365.

Advantageously, the volume of TIM 342 dispensed in this second hardware assembly 300 may be controlled such that the primary reservoir 340 may support repeated plugging/re-plugging cycles. As an illustrative example, aluminum has a Young's modulus of 70 Gpa. This means that, for the top surface 370 made from aluminum having a thickness of 0.4 mm, the top surface 370 can be displaced by the retaining clip 350 by 0.12 mm with 10 lbf. If the volume of the primary fluid reservoir 340 is 1 cm×2 cm×0.5 cm=1.0 cm³), each dispensing will comprise 2.4×10⁻² cm³ of TIM 342, about 2.4% of the primary fluid reservoir 340.

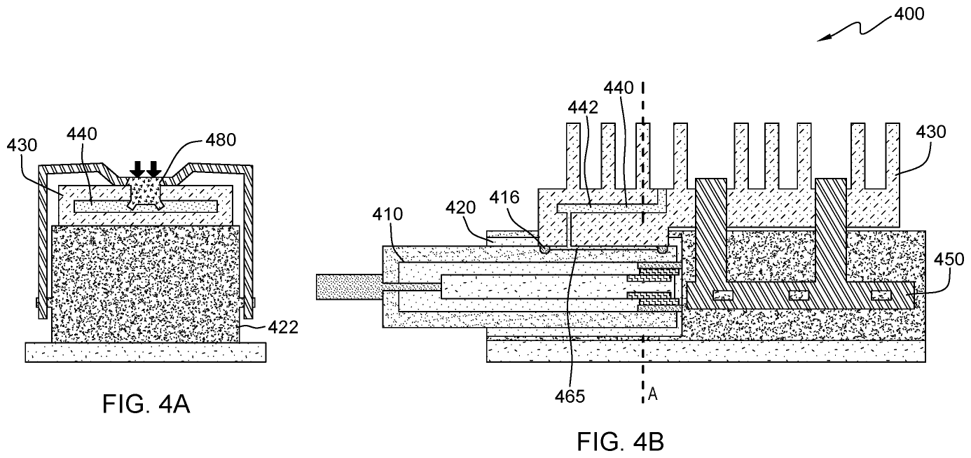

FIG. 4A is a cross-section rear view and FIG. 4B is a cross-section side view of a third hardware assembly 400 suitable for use as one of the system interfaces 114-120, consistent with some embodiments. Hardware assembly 400 is similar to hardware assembly 300 in FIGS. 3A-3B. However, in hardware assembly 400, a primary fluid reservoir 440 may include a movable plug 480. The movable plug 480 may be biased into the primary fluid reservoir 440 by a retaining clip 450. This third hardware assembly 400 may be desirable for some applications because the movable plug 480 may allow for a larger biasing movement than would the flexible top surface 370 in the second hardware assembly 300. This feature, in turn, may allow for dispensing larger amounts of TIM 442 into a secondary fluid reservoir 465 with each plug/re-plug cycle.

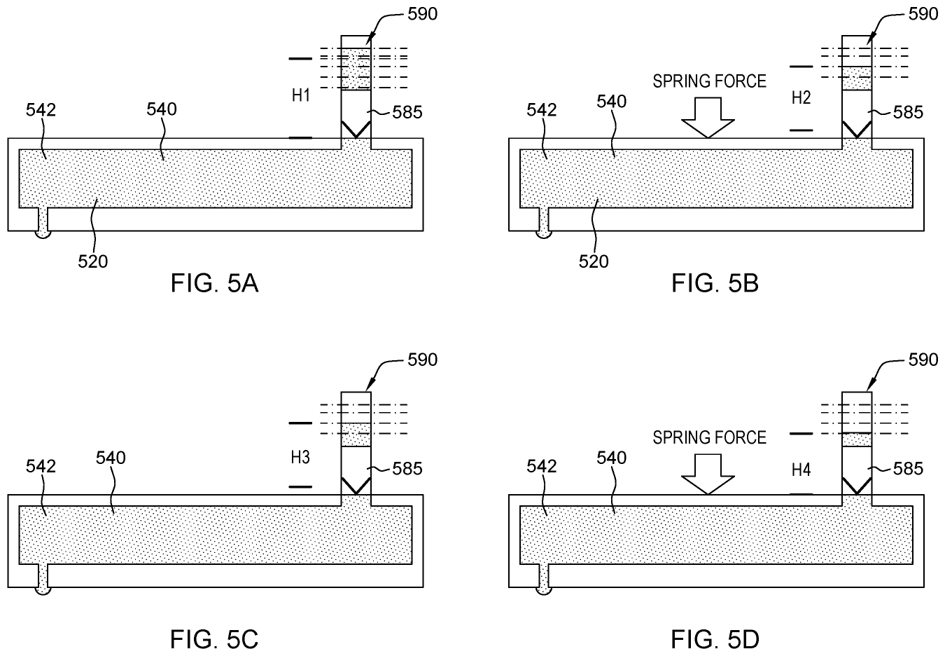

FIGS. 5A-5D are cross sectional views of a first embodiment of upper openings 527 of a primary fluid reservoir 540, consistent with some embodiments. In FIGS. 5A-5D, a check valve 585 has been inserted in a fluid column 590 filled with TIM 542. In operation, FIG. 5A shows the fluid column 590 at a height H1 before a first plugging of the hardware module (not shown) into the socket (not shown). As explained above, this plugging may cause some of TIM 542 to migrate into the secondary fluid reservoir (not shown). FIG. 5B shows the fluid column 590 at a height H2 after the hardware module 510 has been plugged into the socket 520. As shown, H2<H1 because the check valve 585 has allowed some of the TIM 542 material in the fluid column 590 to refill the primary fluid reservoir 540. FIG. 5C shows the fluid column 590 at height H3 after a first removal of hardware module (see previous figures). As shown, H3=H2 because surface tension in the dispensing port 245 (see FIGS. 2A-2B) and/or valve 375 (see FIGS. 3A-3B) may cause the remaining TIM 542 to be retained in the primary fluid reservoir 540. FIG. 5D shows the fluid column 590 at height H4 after the hardware module 510 is re-plugged into the socket 520. As shown, H4<H3 because the check valve 585 has again allowed some of the TIM 542 in the fluid column 590 to refill the primary fluid reservoir 540. Advantageously, however, the check valve 585 does not allow the TIM 542 to flow in the opposite direction, i.e., from the primary fluid reservoir 540 into the fluid column 590. This may be desirable for embodiments in which the TIM 542 is actively biased into the secondary fluid reservoir.

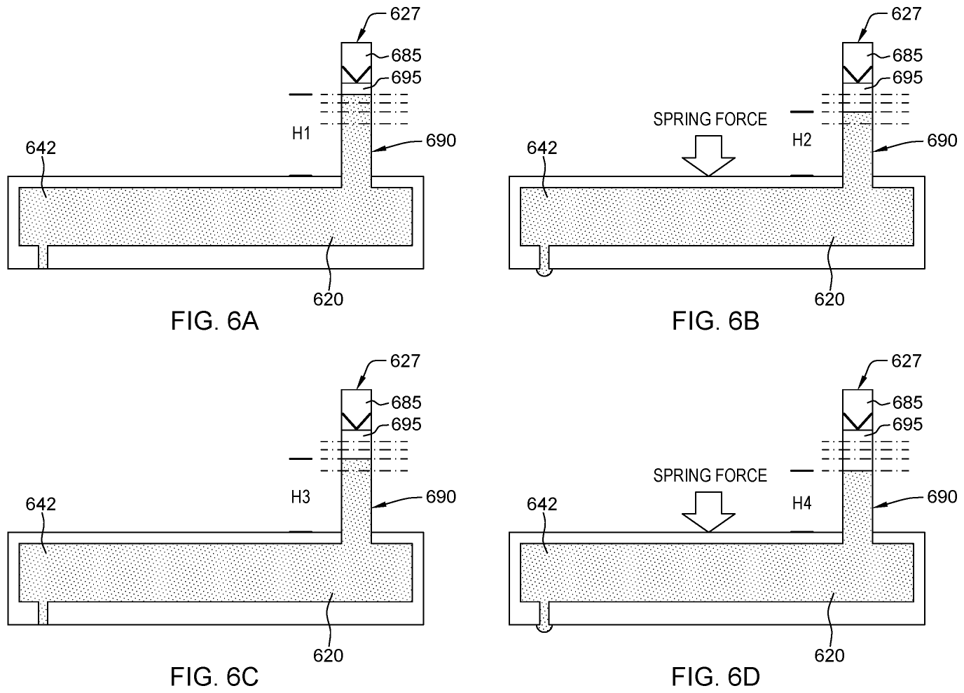

FIGS. 6A-6D are cross sectional views of a second embodiment of upper openings 627 of a primary fluid reservoir 620, consistent with some embodiments. This embodiment is similar to that shown in FIGS. 5A-5D. However, in FIGS. 6A-6B, a check valve 685 is positioned above a level of TIM 642 and is adapted to admit air 695. In operation, plugging/re-plugging of hardware module (see previous figures) causes the TIM 642 flow into a secondary fluid reservoir (not shown), such that H4<H3, H3=H2, and H2<H1. The amount of air 695 in a fluid column 690 may increase to compensate for the reduced volume of the TIM 642 in the primary fluid reservoir 620.

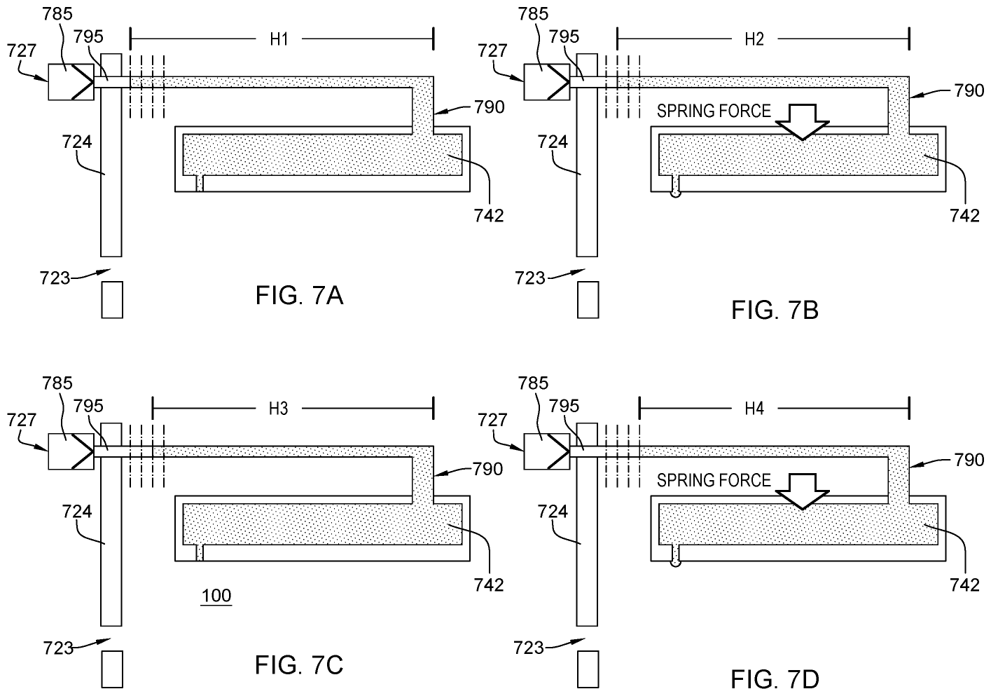

FIGS. 7A-7D are cross sectional views of a third embodiment of upper openings 727 of a primary fluid reservoir 720, consistent with some embodiments. This embodiment is similar to that shown in FIGS. 6A-6D. However, in FIGS. 7A-7B, a fluid column 790 has been routed to an exterior wall 724 of the DPS 100, near an opening 723. In operation, repeated insertion and removal of the hardware module (not shown) causes TIM 742 flow into the secondary fluid reservoir (not shown), such that H4<H3, H3=H2, and H2<H1. A check valve 785 will allow the amount of air 795 in the fluid column 790 will increase to compensate for the reduced level of the TIM 742. Advantageously, the upper opening 727 in FIGS. 7A-7D is accessible from outside the DPS 100, which may optionally allow for refilling of the TIM 742 in the primary fluid reservoir 720 via a “zerk” grease fitting (not shown) or the like.

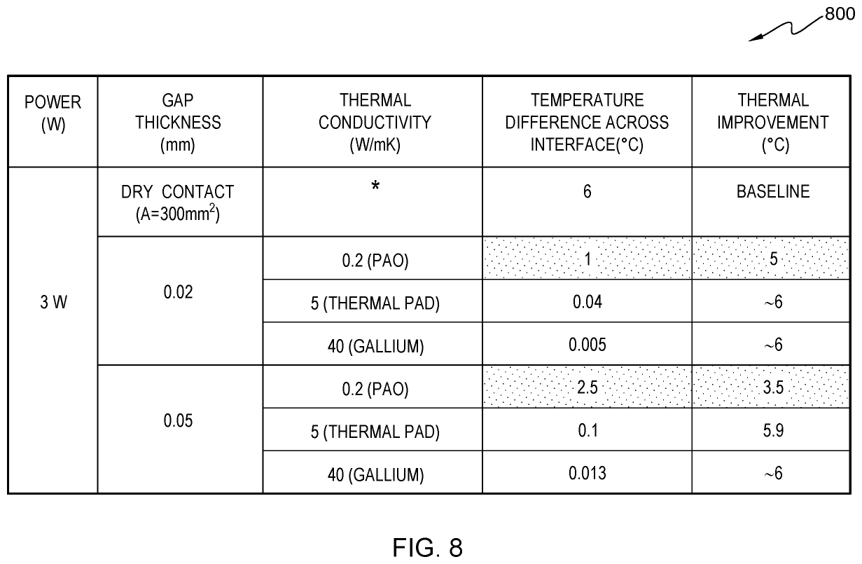

FIG. 8 is a table 800 showing a simulated thermal analysis of traditional dry contact vs. the embodiments disclosed herein. As can be seen, for current generation optical transceivers, some embodiments of this disclosure may significantly decrease the temperature increases during operation from +6-10° C. to +1.0-2.5° C. Moreover, this table indicates that the thermal limitations of current dry contact technology may hamper the future development of these devices, as the forecast usage may lead to temperature increase of as much as +12° C. Embodiments of this disclosure, in contrast, may limit those projected increases to only +2-5° C.

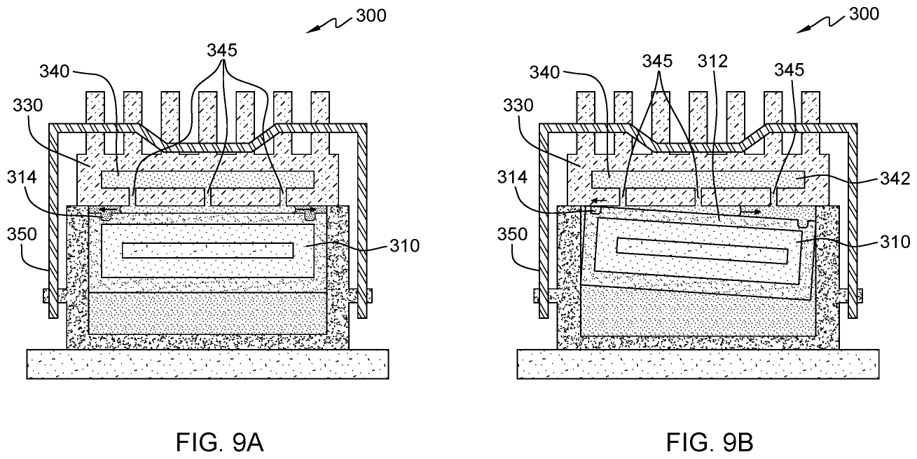

FIGS. 9A-9B are a cross-sectional rear view of the second hardware assembly 300 in operation. More specifically, FIG. 9A illustrates a well-aligned plugging operation, and FIG. 9B illustrates a misaligned plugging operation. In the second hardware assembly 300, the TIM 342 may be dispensed through multiple dispensing ports 345 aligned transverse to the insertion vector. Multiple dispensing ports 345 may help ensure that TIM 342 can be dispensed even in the event of hardware module 310 misalignment during plugging, as shown in FIG. 9B. Additionally, the roughness/pattern in a top surface 312 of the hardware module 310 may capture any excess TIM 342 that is dispensed and prevent any overflow beyond the desired thermal interface area.

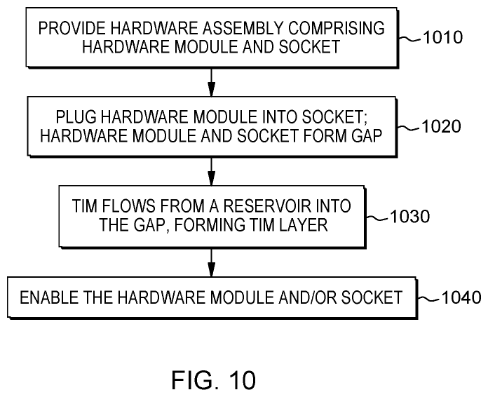

FIG. 10 is a flow chart illustrating one method 1000 of cooling a hardware module in a DPS 100, consistent with some embodiments. At operation 1010, a system administrator provides a hardware assembly, such as hardware assembly 200, hardware assembly 300, or hardware assembly 400. The hardware assembly may comprise a hardware module, such as hardware module 210, hardware module 310, or hardware module 410. The hardware assembly may also comprise a socket, such as socket 220, socket 320, or socket 420. At operation 1020, the system administrator may plug the hardware module into the socket. The hardware module and socket may cooperate to form a gap. At operation 1030, TIM may flow from a reservoir associated with the socket into the gap, forming a TIM layer between hardware module and the socket. At operation 1040, the system administrator may enable the hardware module and/or socket.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A structure for thermal management of pluggable hardware modules, comprising:
a socket assembly adapted to receive a hardware module, the socket assembly comprising an integrated fluid reservoir containing a thermal interface material (TIM), wherein the socket assembly is further adapted to define a gap when the hardware module is plugged into the socket assembly; and
at least one dispensing port in fluid communication with the integrated fluid reservoir and the gap, wherein the at least one dispensing port is adapted to automatically distribute TIM from the integrated fluid reservoir into the gap when the hardware module is plugged into the socket assembly.

2. The structure of claim 1, wherein the hardware module comprises an optical interconnect.

3. The structure of claim 1, further comprising a seal that contains the TIM in the gap.

4. The structure of claim 1, wherein the socket assembly comprises:
a socket; and
a heat sink, the heat sink defining a cavity;
wherein the socket and the heat sink cooperate to define the integrated fluid reservoir.

5. The structure of claim 4, wherein the socket assembly further comprises a retaining clip, wherein the retaining clip is adapted to deflect a flexible surface of the heat sink into the cavity.

6. The structure of claim 4, wherein the socket assembly further comprises a retaining clip, wherein the retaining clip is adapted to bias the plug into the cavity.

7. The structure of claim 1, wherein the TIM comprises a liquid.

8. The structure of claim 7, wherein the liquid comprises polyalphaolefin (PAO) oil.

9. The structure of claim 1, wherein the TIM comprises a thermal grease.

10. The structure of claim 1, wherein the TIM comprises a liquid metal.

11. The structure of claim 10, wherein the liquid metal comprises gallium.

12. The structure of claim 10, wherein the liquid metal comprises Galinstan.

13. The structure of claim 1, wherein the at least one dispensing port is sized such that surface tension forces are balanced with gravity until the hardware module is plugged into the socket assembly.

14. The structure of claim 1, further comprising at least one upper opening in fluid communication with the integrated fluid reservoir, wherein the upper opening is of larger size than the at least one dispensing port.

15. The structure of claim 13, wherein the hardware module comprises an upper surface, the upper surface having a groove along at least one edge.

16. The structure of claim 15, wherein the groove is adapted to receive a seal, wherein the seal retains the TIM in the gap when the hardware module is plugged into the socket assembly.

17. The structure of claim 15, wherein the upper surface is roughened.

18. The structure of claim 15, wherein the upper surface is patterned.

19. An optical transceiver, comprising:
at least one optical module packaged within a housing, wherein:
the housing comprising a generally rectangular top surface defining a pattern adapted to enhance capillary action of a thermal interface material (TIM) applied thereon; and
a groove in the top surface, wherein the groove is adapted to receive a seal when the housing is inserted into a socket.

20. A method of cooling a pluggable hardware module, comprising:
providing a socket assembly, wherein the socket assembly comprises an integrated fluid reservoir containing a thermal interface material (TIM);
providing a hardware module, wherein the hardware module and the socket assembly are adapted to define a gap when the hardware module is plugged into the socket assembly;
providing at least one dispensing port in fluid communication with the integrated fluid reservoir and the gap; and
plugging the hardware module into the socket, wherein the at least one dispensing port is adapted to automatically distribute TIM from the integrated fluid reservoir into the gap when the hardware module is plugged into the socket assembly.
